(19) United States
(12) Patent Application Publication
(10) Pub. No.: US 2026/0070255 A1
(43) Pub. Date: Mar. 12, 2026

(54) SELF-FLOWING TREATMENT OF WOOD, BAMBOO, AND OTHER POROUS MATERIALS

(71) Applicant: University of North Texas, Denton, TX (US)

(72) Inventors: Sheldon Q. Shi, Denton, TX (US); Xuan Wang, Denton, TX (US)

(73) Assignee: University of North Texas, Denton, TX (US)

(21) Appl. No.: 18/872,430

(22) PCT Filed: Jun. 8, 2023
(86) PCT No.: PCT/US2023/024784

§ 371 Date: Dec. 6, 2024

Related U.S. Application Data
(60) Provisional application No. 63/350,968, filed on Jun. 10, 2022.

(51) Int. Cl. B27K 3/04; B27K 3/02; B27K 3/32; B27K 3/52; B27K 9/00; C08H 8/00

(52) U.S. Cl. CPC B27K 3/04; B27K 3/0221; B27K 3/32; B27K 3/52; B27K 9/002; C08H 8/00; B27K 2240/10; B27K 2240/50

(57) ABSTRACT

Methods and systems for self-flowing treatment of wood, bamboo or other porous materials do not require external pressure or complicated equipment. Treatment liquid flows through these porous materials through use of capillary action, the use of absorbent sheets, and differences in pressure. The treatment solution is more evenly dispersed throughout the materials.

This application claims priority to U.S. Provisional Patent Application Ser. No. 63/350,968, filed Jun. 10, 2022, entitled “Self-Flowing Treatment of Wood, Bamboo, and Other Porous Materials,” the entire contents of which are hereby incorporated herein by reference.

### BACKGROUND

This disclosure pertains to methods for the treatment of wood, bamboo, or other porous materials.

Wood and bamboo are the most versatile and widely used materials in the world. Wood products are often considered to be environmentally friendly due to their renewable nature and their ability to store carbon. Wood products, such as beams or lumbers, should have a good resistance to decay and fire so that they can be utilized in exteriors with a long service life or in building constructions satisfying the fire code. They also have inherent defects that can limit their performance in certain applications. Treatments and modifications are being developed to enhance the properties of wood and mitigate its defects, making it an even more versatile and sustainable material.

Wood and bamboo have experienced a renewed interest and has been the focus of numerous innovative applications, ranging from transparent wood or bamboo for windows to superhydrophobic wood or bamboo for marine applications and self-healing wood for damage restoration. Additionally, they have been instrumental in the development of novel biomaterials like nanocellulose, which have found widespread application across several industries such as healthcare and food packaging. The incorporation of wood in electronics has also seen significant strides, where environmentally friendly alternatives to traditional plastics and metals like magnetic wood and wood-derived nanocellulose film are being developed.

The dominant method of wood preservation and fire treatment is the impregnation of preservatives or fire retardants into the wood.

Besides the functionalization of natural wood/bamboo, in recent years a strong focus has been on modifying wood/bamboo by partial or full delignification treatments while retaining the beneficial fiber directionality and the hierarchical structure of the original material. Nanowood is a new material that is prepared by removing the lignin from natural wood. It is a highly porous and lightweight material that consists mostly of cellulose nanofibers. Because the material is highly porous, it contains a lot of air pockets that act as insulators, preventing heat from passing through the material. This makes it an attractive material for use in thermal insulation applications. In addition, a new type of densified wood bamboo has been developed that exhibits exceptional mechanical properties. This wood was prepared by first delignifying natural wood using a chemical treatment, and then compressing the resulting material at high temperatures and pressures. The densified wood has several desirable properties, including; high strength and stiffness, increased hardness, and improved dimensional stability. It is also less prone to cracking, warping, and splitting than natural wood/bamboo.

Wood, bamboo or other porous plant-derived materials are often desirable due to their natural abundance, sustainability, and unique physical and mechanical properties. Most wood modifications involve chemical treatments. However, during the chemical treatment of these materials, one common limitation is the inhomogeneity of the resulting material. This is largely due to the difficulty of achieving consistent penetration of the chemicals into these natural fibers. The inconsistent chemical penetration of wood presents a significant challenge for the production of large-scale functionalized wood or bamboo-based materials. Traditional impregnation methods, such as vacuum-pressure or dip-coating, can result in uneven penetration and limited depth of chemical treatment, which can impact the overall quality and properties of the final product. An alternative strategy is to break it down into smaller pieces for chemical treatment and then mix it with polymers. However, while this approach may reduce the size of the wood for easier handling, it can compromise the structural integrity of the material and increase the cost and complexity of the production process.

Challenges remain in scaling up the production of functionalized wood or bamboo-based materials, although some new impregnation techniques have been reported. One of the most successful techniques is supercritical fluid technology, which uses supercritical carbon dioxide as a solvent to penetrate the wood/bamboo and carry the desired chemicals into the structures of these materials. These methods have shown promising results for more uniform penetration and greater depth into these materials. However, they are inefficient and expensive to use.

### SUMMARY

The present disclosure relates generally to methods for the treatment of wood, bamboo, or other porous materials.

In particular, the present disclosure relates to a self-flowing method for treatment of wood or porous materials. The term “wood” may be used herein as a reference to all porous treatable materials.

Methods described herein allow a treatment solution to flow through porous material quickly with no external pressure and no complicated equipment. A treatment agent flows from a liquid storage tank into a treatment tank, which holds the material to be treated, and into a waste liquid collection tank. The treatment agent can be a variety of chemical solutions, preferably in a liquid form with preferred viscosity below 100 mPa·S. The liquid flowing through the wood will have an intimate contact with the inner wood cells and/or fill the pores. The chemicals brought into the wood can either serve as a protection or functional agent of wood (i.e., preservative, fire retardant, etc.) or be reaction agents (H₂O₂, NaClO, NaClO₂, NaOH, and etc.) which can react with the target component of wood (i.e., lignin, extractives) so that the reacted component can be brought out from the wood through the self-flowing process (i.e., lignin removal). An absorbent sheet transfers the treatment agent from the top of the material in the treatment tank, after it passes through the material, into the waste liquid collection tank. This self-flowing process allows uniform treatment of the porous material with high speed.

The self-flowing processes described herein are inspired by the water transportation process for a green tree. The presence of natural vessels and fibers induces a capillary force that draws liquid into the wood mainly from the bottom surface. By mimicking this natural process, unprecedented consistency can be obtained in both chemical penetration and reaction, even in large wood samples. In addition, the process allows the post-reaction liquid extracted from the top of the wood be easily collected for reuse or regeneration for other applications. The disclosed methods can be applied to treat wood, bamboo, agricultural plant and other porous materials, without limitation.

The disclosed methods are also appropriate to obtain products including but not limited to: preservative treated lumber, termite treated lumber, fire-retardant treated wood, delignified wood, densified wood, transparent wood, wood products with high dimensionally stability and other functionalities (e.g., magnetic wood, fluorescent wood, conductive wood, etc. using nanoparticle treatments).

The self-flowing process is a sustainable and cost-effective alternative to conventional wood modification techniques, using natural forces to introduce liquid into the wood without the need for external energy sources. It has a wide range of applications in the fields such as timber preservation, composite materials, and wood modification.

### BRIEF DESCRIPTION OF THE DRAWINGS

FIG. 1 shows a schematic of principles of self-flowing methods for treatment of wood, according to preferred embodiments disclosed herein.

FIG. 2 shows a schematic of a self-flowing system for wood treatment, according to preferred embodiments described herein.

FIG. 3 shows scanning electron microscopy (SEM) images of delignified wood microstructure of (a), (b), and (c) cross-sections of the delignified wood after self-flowing treatment, (d), (e), and (f) cross-sections of the delignified wood after treatment with immersion, and (g), (h), and (i) cross-sections of the delignified wood following vacuum treatment.

FIG. 4 shows an illustration of sample locations every 5 mm apart across the width of the wood, where boxes represent the areas where lignin was measured.

FIG. 5 shows lignin content in samples treated using three different treatment methods—immersion, vacuum, and self-flowing.

FIG. 6 shows the results of a comparison of the thermal conductivity of untreated wood, and delignified wood treated with immersion, vacuum and self-flowing methods at room temperature.

FIG. 7 shows images of wood compressed from (a) delignified wood prepared by the self-flowing technique and (b) delignified wood prepared by the immersion technique, (c) thickness changes of densified wood, and (d) density changes of densified wood.

FIG. 8 shows images of curcumin/salicylic acid tested surfaces of (a) untreated wood and borate-treated wood treated with (b) immersion method (c) vacuum method, and (d) self-flowing method, and (e) penetration depth of borate for each type of tested surface.

FIG. 9 shows an analysis of heights and liquid levels based on a self-flowing system for wood treatment, according to preferred embodiments described herein.

FIG. 10 shows (a) the relationship between the liquid level differences (t4) and borate flow rate and (b) the relationship between the liquid level differences (t4) and the time required to completely treat basswood samples.

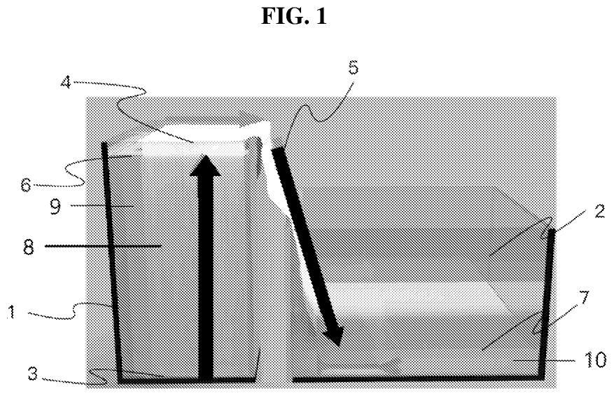

FIG. 1I shows (a) the relationship between the cross-sectional area of wood (A) and the borate flow rate, and (b) the time required for complete treatment of a basswood sample with different cross-sectional areas.

FIG. 12 shows (a) the relationship between the height of wood (t1) and the flow rate of borate, and (b) the relationship between the height of the basswood sample (t1) and the time required for complete treatment of basswood samples.

FIG. 13 shows (a) the relationship between the liquid level differences (t4) and borate flow rate and (b) the relationship between the liquid level differences (t4) and the time required to completely treat the balsa wood samples.

FIG. 14 shows (a) the relationship between the cross-sectional area of wood (A) and the borate flow rate, and (b) the time required for complete treatment of wood with different cross-sectional areas.

FIG. 15 shows (a) the relationship between the height of wood (t1) and the flow rate of borate, and (b) the relationship between the height of wood (t1) and the time required for complete treatment of balsa wood samples.

### DETAILED DESCRIPTION OF PREFERRED EMBODIMENTS

The present disclosure relates to methods for treatment of wood and porous materials using a self-flowing technique that does not require external pressure or complicated equipment.

FIG. 1 shows a schematic of the principles of self-flowing methods for treatment of wood, according to preferred embodiments disclosed herein.

In FIG. 1, arrows indicate the preferred direction of liquid flow. Treatment tank 1 is a treatment container for the wood 8 to be treated with fresh desired treatment solution 9. Storage tank 2 is a storage container used to store the used solution 10 drawn from the wood 8. Wood 8 has a lower surface 3 and an upper surface 4 of the wood, respectively. Absorbent sheet 5 is an absorbent material used to draw, the solution 9 from the wood 8 and transfer to storage tank 2. Liquid level 6 in treatment tank 1 is much higher than liquid level 7 in storage tank 2.

The principle of self-flowing treatment method is illustrated in FIG. 1. The presence of natural vessels and/or fiber tracheid's in wood 8 induces a capillary force that draws liquid into wood 8 mainly from the bottom surface 3. The treatment happens in treatment tank 1. As the liquid level 6 is much higher than the lower surface 3 of wood 8, the liquid inside wood 8 will be pulled upward under the capillary force and pressure difference. Using a special absorbent sheet 5, a continuous liquid flow occurs from the bottom of the wood to the top. For the absorbent sheet 5, one end is placed over upper surface 4 of wood 8 without directly contacting the liquid 9. The other end of the absorbent sheet 5 is placed in storage tank 2. The treatment liquid 9 flows through wood 8 in treatment tank 1 and is pulled into storage tank 2 through the absorbent sheet 5, No additional external pressure is required throughout the entire process. The self-flowing process allows the wood to keep the liquid flowing through itself.

The self-flowing process is an innovative and eco-friendly technique for introducing liquid into wood. As depicted in FIG. 1, this process involves treating the wood in a left tank, where the presence of natural vessels and fibers induces capillary forces that draw the liquid into the wood, primarily from the bottom surface. The capillary forces are augmented by a pressure difference that promotes the upward movement of the liquid, resulting in a continuous flow through the wood. To facilitate this process, an absorbent sheet is used, which is placed at one end over the top of the wood, without direct contact with the liquid. The other end of the sheet is then placed in a separate tank, which draws the liquid through the wood via capillary action. Through the self-flowing process, the wood can sustain a liquid flow within itself, simulating the natural processes observed in green trees.

Chemical treatments of wood can be classified into two major categories based on the way the chemical agent interacts with wood. The first category involves a chemical reaction between the agent and wood components, resulting in a change in the wood's original properties. The second category involves a treatment in which the agent remains in the wood and imparts a specific function to it. The delignification of wood is an example of the former, where wood is treated with chemicals to remove lignin, hemicelluloses, and other wood components to improve its porous structure and mechanical properties. Preservative treatment of wood is an example of the latter, where wood is treated with chemical agents to prevent decay, insect attack, and other types of damage. Borate is a widely used preservative that helps protect wood from decay and fire.

Accordingly, preferred embodiments described herein relate to a self-flowing system for treatment of wood comprising a treatment container, where the treatment container is at least partially filled with a treatment solution, wood or a porous material to be treated, where the wood is placed in the treatment container and immersed at least partially in the treatment solution, a storage container, and an absorbent material that traverses between the treatment container and the storage container and is in contact with the upper surface of the material to be treated, such that the treatment solution flows from the treatment container to the storage container through the porous material to be treated, such as wood, to the storage container, pulled through the absorbent material. The treatment solution passes from a lower surface of the wood and through the wood to an upper surface of the wood at least in part via capillary force.

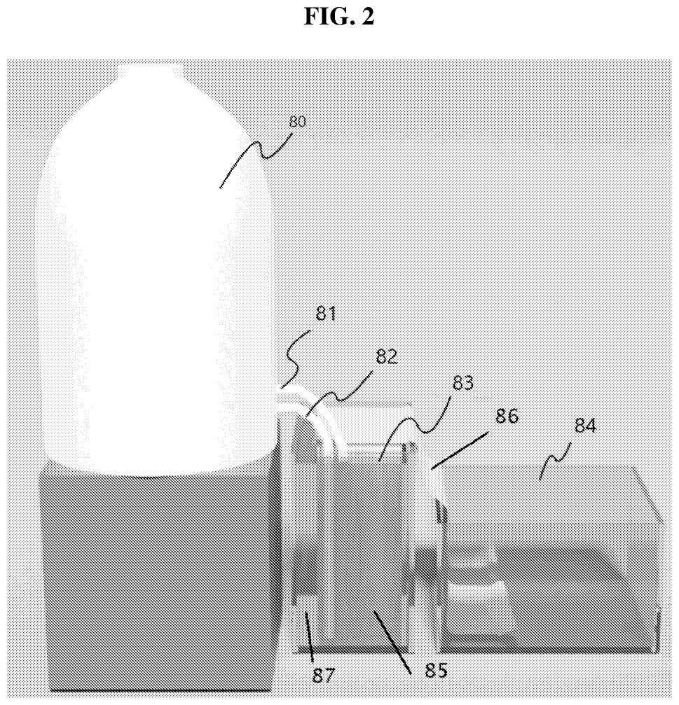

Preferred embodiments described herein also relate to a self-flowing system for treatment of wood as shown in FIG. 2. In this embodiment there are preferably three tanks: liquid storage tank 80 (Tank 1), treatment tank 83 (Tank 2), and waste liquid collection tank 84 (Tank 3). An air intake pipe 81 and liquid outlet pipe 82 are at the bottom of Tank 1. The intake pipe 81 is short, and its end is slightly below the top surface of the wood 85. The outlet pipe 82 is longer, and its end is below the air intake pipe 81. The size of Tank 2 is designed based on the size of the wood 85. The wood sample 85 to be treated is placed in Tank 2 for chemical reaction with a liquid 87 containing one or more chemical agents. Tank 2 can be heated separately. An absorbent sheet 86 was used to transfer the chemical solution from Tank 2 to Tank 3. One end of the absorbent sheet 86 is placed over the top of the wood 85 without directly contacting the liquid. The other end of the absorbent sheet 86 is placed in Tank 3.

For some treatments that require to be carried out at elevated temperatures, heating elements can be designed into the treatment tank (Tank 1) so that a desired temperature can be achieved for the self-flowing process.

In preferred embodiments, the chemical agents for self-flowing treatment include but are not limited to: H₂O, H₂O₂, NaClO, NaClO₂, CH₃COOH (Acetic acid), HCOOH (Formic acid), H₂SO₄, ClO₂, Cl₂, NaOH, Na₂S, C₄H₆O₂ (furfuryl alcohol), NaHSO₃, SO₂, Ammonia or amine based preservatives, such as ACQ and ACiZA, Na₂SO₃, (C₂H₅)₂O (Diethyl ether), CH₃OH (Methanol), C₇H₈O (Benzyl alcohol), C₃H₆O (Acetone), C₂H₁₅OH (Ethanol), C₄H₁₆O₃ (Acetic anhydride), C₄H₉OH (Butanol), NH, NH₃—H₂O, CH₂Cl₂ (Dichloromethane), C₅H₁₀N₂O₅ (dimethyloldihydroxyethylenerurea), H₆NO₄P (Ammonium dihydrogenphosphate), borate, particulate suspension, triethanolamine C₁₆H₂₂ClN₃O (Tebuconazole), C₁₅H₁₇Cl₂N₃O₂ (Propiconazole), C₆HCl₅O (Pentachlorophenol), or a combination thereof.

In preferred embodiments, the absorbent sheet can be made from cloth, paper, or other synthetic materials (e.g., nylon, polyester, acrylic, polyurethane, polyolefin, acetate, aramid fiber, glass fiber, quartz fiber and the like), plant-based fiber (e.g., cotton, flax, hemp, jute and the like), animal-based fiber (e.g., wool, silk and the like) or a mixture thereof. It is preferred that the absorption speed be greater than 0.1 cm. Absorption speed is the distance in cm that liquid will travel in an upright strip of paper in ten minutes at 20° C. It is also preferred that the thickness of the absorbent sheet be greater than 0.1 mm, and it can be folded to increase its thickness. Depending on the material, the density of absorbent sheet preferably ranges from 0.1 g/cm³ to 2 g/cm³.

The described self-flowing process will work better when the wood to be treated has a high moisture content (i.e., green lumber/timber). For wood with low moisture content (not much water in the vessel or tracheid), the initial liquid flow through the wood may require a longer time. To accelerate the initial liquid flow, one method is to use a low surface tension liquid (i.e., hexane, methanol, etc.) first to initiate the liquid flow through the wood, and then the desired treatment solution can be applied so that the treatment process can be significantly accelerated.

### EXAMPLES

### Experimental

Material. Basswood (Tilia americana) and Balsa (Ochroma pyramidale) were used in these examples. Sodium chlorite (NaClO₂, 80%) was purchased from Alfa Aesar (Haverhill, MA). Sodium tetraborate decahydrate was purchased from Fisher Scientific (Hampton, NH). Acetic acid, sodium hydroxide, turmeric, ethyl alcohol, hydrochloric acid, and salicylic acid were obtained from Sigma-Aldrich (St. Louis, MO), and all other chemicals were used as received.

Construction. An embodiment of a self-flowing system was constructed according to FIG. 2 and as described above.

Samples. Delignification solution was prepared. Briefly, wood samples were treated with 2% NaOH solution at 90° C. for 2 h and then treated with 3% NaClO₂ solution at 80° C. for 3 h. The 3% NaClO₂ solution was prepared by dissolving NaClO₂ powder in DI water, By adding acetic acid, the pH value of the NaClO₂ solution was adjusted to 4.6. Before treatment with NaClO₂, the wood should preferably be washed with DI water until neutral to ensure the removal of residual NaOH. After delignification treatment all wood samples were freeze-dried for characterization.

To compare the differences between the delignification processes, the wood samples were delignified by the self-flowing process described herein, a vacuum process and an immersion process under the same chemical treatment conditions.

For the self-flowing process, the wood samples were stored in water before use. The outlet pipe and air intake pipe were clamped. The 2% NaOH solution was poured into Tank 1 through the top opening, then the opening was closed. The wood sample was placed in Tank 2 which was heated to 85° C. with a water bath. The clamp at the outlet pipe and air intake pipe was removed to start the flow of solution from Tank 1 to Tank 2, When the liquid solution level reached the air intake pipe, the air intake pipe was closed by the solution so that the flow to Tank 2 was stopped. The 2% NaOH solution will continuously flow from the bottom of the wood through the absorbent sheet into Tank 3. After treatment with NaOH solution for 2 h, the wood samples were fully washed by changing the NaOH solution in Tank 1 to DI water. Then, wood samples were treated with NaClO₂ solution for 3 h using the same process.

For the immersion process, the wood samples were immersed directly in NaOH solution, DI water and then NaClO₂ solution.

The preparation of densified wood followed the methodology described by Song et al (Song, J., et al., Processing bulk natural wood into a high-performance structural material, Nature, 554 (7691), 224-228 (2018)). Initially, natural wood blocks were treated with an aqueous solution consisting of mixed 2.5 M NaOH and 0.4 M Na₂SO₃ at boiling temperature. The treatment was carried out using both immersion and self-flowing methods. The lignin content of the treated wood was reduced by approximately 45%. Subsequently, the wood blocks were subjected to a hot-pressing process at 100° C. and a pressure of approximately 5 MPa for 24 hours to achieve densification.

Characterization. The sample micromorphology was examined using the scanning electron microscope (SEM, Quanta 200). These samples were gold sputtering coated for 20 s before the examination. The 20-kV acceleration voltage and 10-ms dwelling time were applied. The mechanical properties of the samples (165 mm long×13 mm wide×1 mm thick) were measured using an AGS-X universal testing machine in accordance with the procedure described in A STM D638.

The lignin (Klason lignin) contents were determined based on the Standard of TAPPI T 222 om-02. 1.0 g dry wood was extracted for 8 h, and then treated with 72% sulfuric acid (15 mL) for 2 h at 20° C. After adding 560-mL DI water, the mixture in a beaker was diluted to 3% concentration of sulfuric acid, and then boiled for 4 h, After cooling down, the mixture was filtered and washed with the DI water. To obtain the ash weight, according to TAPPI T 211 om-02, the insoluble substances were dried and weighed before transferring to a muffle furnace at 525° C. The content of lignin was calculated using the following equation:

$$Lignin content = \frac{{m}_{1} - {m}_{2}}{{m}_{0}} \times 100 \%$$

where m₁ is the weight of insoluble materials, m₂ is the weight of ash, and m₀ is the oven-dried weight of the specimen.

The measurement of heat conductivity was conducted using a I-lot Disk heat conductivity meter (TPS 1500, Thermtest Inc.). The Hot Disk includes both the heat source and the resistance thermometer.

The depth of borate impregnation in was conducted according to the American Wood Protection Association (AWPA) A68-22 standards. Briefly, two solutions were prepared for this test. Solution 1 was made by extracting 10 grams of turmeric with 90 grams of ethyl alcohol. Solution 2 was created by diluting 20 milliliters of concentrated hydrochloric acid to 100 milliliters with ethyl alcohol and then saturating it with salicylic acid (about 13 grams per 100 milliliters). Samples with dimensions of 5 cm by 5 cm were used for the penetration assay and were dried prior to making the final cut to expose the surface for spraying. All samples were cut down the middle in the direction of the wood growth. Solution 1 was applied by spraying onto the test surface and allowed to dry for 10 minutes. Solution 2 was then applied similarly to the areas that had been colored yellow by the application of Solution 1. The color changes were observed carefully and appeared after the application of the second solution. In the presence of boron, the yellow color of the turmeric solution turns red. After reagent application, the wood was placed in a warm oven to accelerate and intensify the color reaction, allowing for better differentiation between treated and untreated wood.

Delignification. To evaluate the effectiveness of the self-flowing treatment method involving a chemical reaction between the agent and wood components, we conducted a delignification treatment on the wood samples. Two other treatment methods, the immersion and vacuum method, were also employed for comparison. The delignification treatments were carried out for a duration of 3 hours tinder identical conditions. Details of the experimental procedure are discussed above.

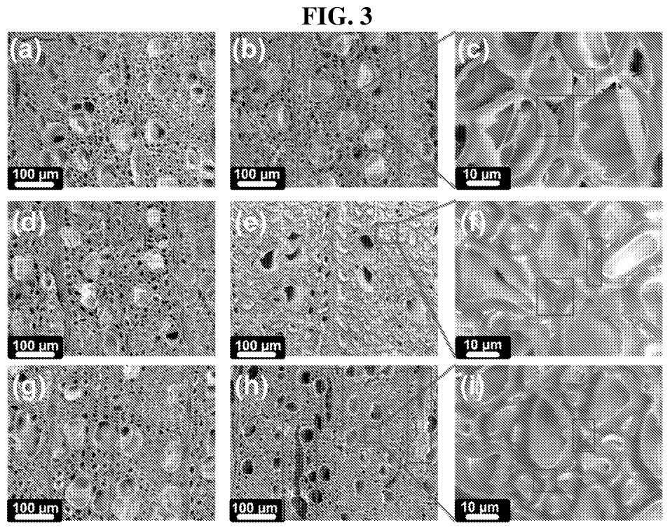

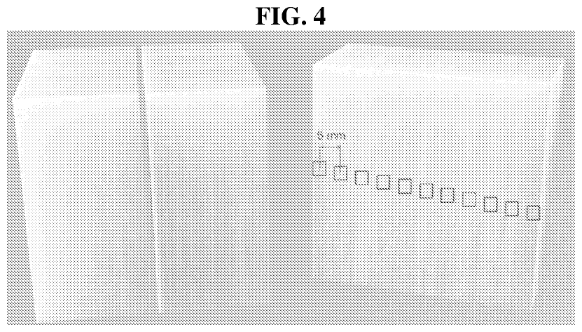

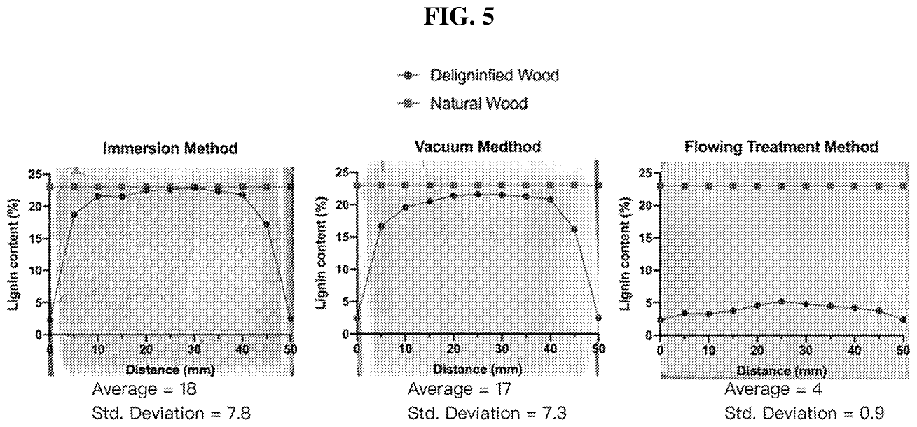

FIG. 3 shows scanning electron microscopy (SEM) images of the delignified wood microstructure. The SEM images in FIG. 3 provide a visual representation of the microstructure of delignified wood, which can be useful in understanding the effects of different delignification methods (self-flowing, immersion, and vacuum) on the structure of the wood. FIG. 3(a), (b), and (c) shows images of cross-sections of the delignified wood with self-flowing treatment, where FIG. 3(a) shows the outer part of the sample, FIG. 3(b) shows the inner part of the sample, and FIG. 3(c) is a magnified SEM image of the inner part of the sample. FIG. 3(d), (e), and (f) show images of cross-sections of the delignified wood with immersion, where FIG. 3(d) shows the outer part of the sample, FIG. 3(e) shows the inner part of the sample, and FIG. 3(f) is a magnified SEM image of the inner part of the sample. FIG. 3(g), (h), and (i) show images of cross-sections of the delignified wood with vacuum treatment, where FIG. 3(g) shows the outer part of the sample, FIG. 3(h) shows the inner part of the sample, and FIG. 3(i) is a magnified SEM image of the inner part of the sample.

All specimens were cut in half to obtain both exterior and interior samples, which were then examined separately under a scanning electron microscope (SEM). The self-flowing delignified wood samples had a more porous structure and thinner cell walls, both inside and outside, compared to the samples obtained by the immersion and vacuum methods, as shown in FIG. 3(a)-3(c). For delignified wood samples obtained by immersion (FIG. 3(d)-(f)) and vacuum (FIG. 3(g)-(i)), it was observed that only exterior of wood samples had porous structures as shown in FIGS. 3(d) and (g). Interior samples (FIGS. 3(e) and (h)) of immersion and vacuum had less porous structures and thicker cell walls than exterior samples. The porous structures were mainly caused by the removal of hemicellulose and lignin components from the cell walls during the delignification process, which can be clearly seen by comparing the magnified images in FIG. 3(c), (f), and (i). Removal of these components, originally present in cell walls, created small cavities which may be observed in SEM images. The presence of these voids can also increase the shrinkage of the cell walls. As a result, the cell wall structure becomes thinner.

It is also worth noting that lignin is present in large amounts at the corners of the cells. The removal of lignin can create voids in this part of the samples, which can be observed in the boxes in FIG. 3(c), (f), and (i). Additionally, the delignified wood samples treated with the vacuum method showed a large number of cracks, as seen in the boxes in FIG. 3(h). This is mainly due to the more fragile connections of the wood cells in the delignified wood, which accumulated a large amount of pressure inside the wood when the vacuum pressure was released. This pressure ultimately resulted in the destruction of the wood structure. The cracks observed in the vacuum-treated samples can have a significant negative impact on the mechanical properties of the wood. These effects can limit the potential applications of the delignified wood. This phenomenon was not found in the samples treated by the self-flowing and immersion methods, which suggests that the vacuum method may not be as suitable for delignifying wood as the other two methods in terms of structural integrity.

It can be concluded that the self-flowing method leads to a more homogenous delignification of the wood samples, resulting in a more porous structure and thinner cell walls throughout the samples. The immersion and vacuum methods, on the other hand, led to a more heterogeneous delignification, resulting in a more porous structure on the exterior of the samples and less porous structure in the interior of the samples, Additionally, the vacuum method caused cracks to appear in the delignified wood samples, which can be detrimental to the properties of the wood.

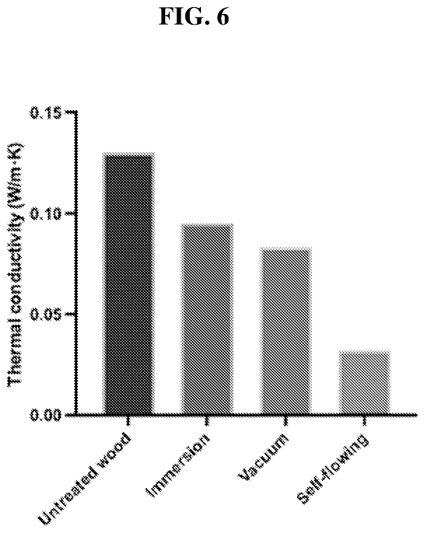

To determine the distribution of lignin within the wood samples after treatment, the wood sample was cut through the middle. The lignin contents were measured on the sample locations every 5 mm apart across the width of the wood as shown in FIG. 4. The boxes represent the areas where lignin was measured.

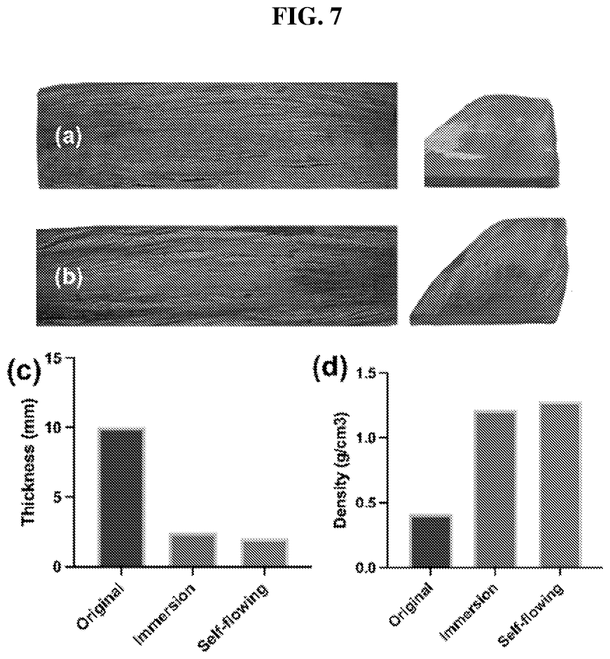

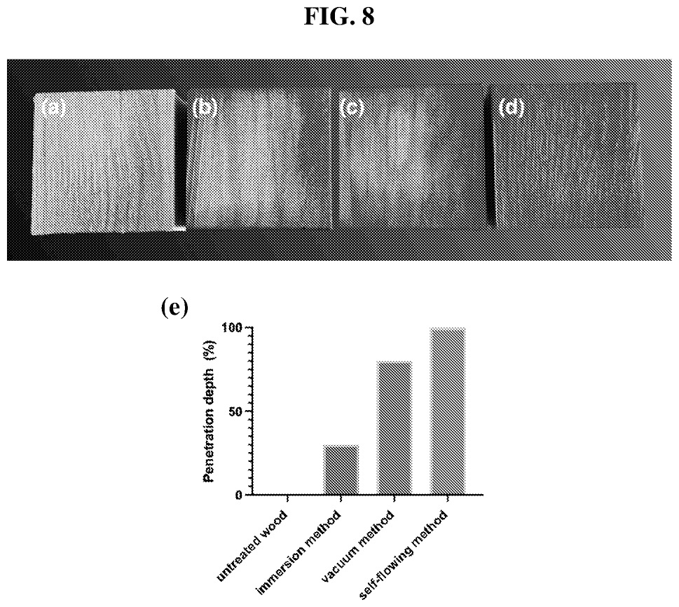

FIG. 5 shows the lignin content in samples treated using; the three different treatment methods (immersion, vacuum, and self-flowing). As shown in FIG. 5, for the delignified wood samples obtained using both immersion method and vacuum method, the lignin content at the surface of the sample was decreased to below 5% (from 23%, about 74% reduction), while lignin content was around 20% for the rest portions of the wood sample (about 13% reduction). The standard deviation of the distribution of lignin content was about 8.

For the delignified sample obtained from self-flowing treatment, the lignin content for both surface and interior locations of the wood sample decreased to below 5% (about 74% reduction). The standard deviation of the lignin content distribution was only 0.7.

From these results, it shows that the presented self-flowing treatment allows sufficient reaction of the solution throughout the wood sample, presenting a uniform treatment. In contrast, for the other two methods, the reaction mainly happened on the wood surface. This can have implications for the properties and potential applications of the delignified wood samples, as a more uniform removal of lignin may lead to improved properties and a wider range of potential uses.

Thermal insulation performance. The removal of lignin from wood results in a porous and lightweight structure that is ideal for use as a scaffold. One significant application of delignified wood scaffold is in thermal insulation. The porous structure allows for efficient trapping of air, which makes it an excellent insulator against heat transfer. Delignified wood has a significantly lower thermal conductivity compared to natural wood and is even lower than most conventional insulation materials. Additionally, it is biodegradable and environmentally friendly, making it a suitable option for energy-efficient buildings, electrical equipment, and other applications. A comparative experiment was performed to investigate the thermal insulation between the self-flowing treated delignified wood and the other two delignification methods (immersion and vacuum methods).

FIG. 6 shows the results of a comparison of the thermal conductivity of untreated wood, and delignified wood treated with immersion, vacuum and self-flowing methods at room temperature.

The thermal conductivity of untreated wood, as well as delignified wood obtained through the immersion method, the vacuum method, and the self-flowing method, were all compared perpendicular to the grain. The experimental results revealed that the thermal conductivities of these samples were 0.131, 0.095, 0.083 and 0.032 W/m IK respectively. This trend was consistent with the lignin content of the samples, as the thermal conductivity of the wood decreased as the lignin content decreased.

The delignified wood prepared by the self-flowing method had the lowest thermal conductivity due to the lowest and uniform lignin content among the samples. The removal of lignin increases the porosity of the samples. This large porosity leads to a much smaller thermal conductivity. Additionally, the removal of lignin reduces the linkage among cellulose fibrils and the fibril aggregates within the fibril wall, leading to weaker interaction between fibrils and reducing the thermal conductivity in the transverse direction. Therefore, in terms of thermal insulation properties, the samples prepared by the self-flowing treatment method have an advantage over the other two methods.

Densification. Lignin is a natural substance found in wood that gives it its rigidity and strength. However, it also makes wood difficult to bend and compress. By removing some lignin through delignification treatment, wood becomes more flexible and easier to compress (Song et al., 2018). This increased flexibility and compressibility can be particularly beneficial in the production of densified wood. Densified wood is created by compressing wood fibers together to increase its density and strength. Delignification treatment can significantly improve the density and compression rate of densified wood, resulting in a stronger and more durable material that is suitable for a wide range of applications. To explore the distinctions between densified wood prepared by the self-flowing delignification method and that produced by the conventional delignification approach, a comparative test was conducted.

The density and compression ratio of the densified wood are key indicators of its effectiveness. The quality of the delignified wood also plays a role in determining these indicators. Densified wood was prepared using both self-flowing and immersion delignification methods. FIG. 7 shows images of wood compressed from (a) delignified wood prepared by the self-flowing technique and (b) delignified wood prepared by the immersion technique, (c) thickness changes of densified wood, and (d) density changes of densified wood.

As seen in FIG. 7(a)-(b), the appearance of the densified wood was similar. However, as shown in FIG. 7(c), the thickness of the densified wood compressed using the self-flowing method was slightly thinner than that of the immersion method. Under the same 5 MPa pressure, the immersion-treated wood was compressed from 10 mm to 2.43 cm, while the self-flowing method compressed the wood to 2.02 cm, resulting in thickness reduction ratios of 76% and 80%, respectively. Additionally, the density of both woods increased from 0.41 g/cm³ to 1.21 g/cm³ and 1.28 g/cm³, respectively, showing that the self-flowing method resulted in higher compression and density compared to the immersion method. It is worth noting that both delignified woods had a controlled lignin removal of 45% to achieve higher density. At 60% lignin removal, the density of the wood decreased to 1.08 g/cm³ and 1.12 g/cm³, although the compression ratios were increased to 85% and 87%. This demonstrates that while lignin removal can increase the compression rate of wood, it also decreases the density. To obtain higher density, it is important to optimize the amount of lignin removal from wood at around 45%. The higher density of self-flowing densified wood is due to the uniformity of lignin removal, as opposed to the uneven removal in the immersion method. Therefore, the self-flowing treatment method is a preferable method for the preparation of densified wood with higher compression rate and density.

Borate treatment, Besides its benefits in chemical treatments that involve reactions with wood, the self-flowing method also excels in treatments that do not require chemical reactions with the wood, such preservative impregnation treatment. Borate is a type of wood preservative that utilizes naturally occurring minerals to protect wood from various organisms that can cause decay and damage. These preservatives are low in toxicity, making them safe for use in indoor settings where the treated wood is protected from weather elements. The preservatives penetrate the wood and prevent the growth of fungi, termites, and other wood-decomposing organisms. This makes borate wood preservatives a popular choice for builders, architects and homeowners for their effectiveness and non-toxicity.

The main challenge of this type of preservative treatment is to ensure that the preservative is impregnated deep enough into the wood to provide adequate protection. An investigation was made into the effectiveness of the self-flowing impregnation method for borate wood preservatives. Traditional impregnation methods such as immersion and vacuum impregnation were used for comparison with the self-flowing impregnation method.

The study's methodology involves treating the wood samples with an aqueous borate solution. The depth of borate impregnation was then tested by sawing the wood axially along the growth direction. The depth of borate impregnation was determined according to the method described in the American Wood Protection Association (AWPA) A68-22 standards. The presence of boron on a freshly cut sample of treated wood was visually determined by adding two color regents which turn boron-treated wood red.

FIG. 8 shows images of curcumin/salicylic acid tested surfaces of (a) untreated wood and borate-treated wood treated with (b) immersion method (c) vacuum method, and (d) self-flowing method, and (e) penetration depth of borate for each type of tested surface. The wood samples were colored red to varying degrees after the reaction of the two agents with color. The wood treated with the self-flowing method showed the reddest color. The untreated wood did not show any presence of borates. The wood treated with the self-flowing method had a borate impregnation depth of 100%, indicating a complete penetration of the preservative throughout the entire sample.

When comparing the results of the self-flowing method to the traditional immersion and vacuum methods, the self-flowing method provides a deeper depth of impregnation. The approximate area covered by borates in the wood treated by the immersion method was about 30%, while the wood treated by the vacuum method had an approximate area covered of 80%. Therefore, the self-flowing impregnation method has a significant advantage over the traditional immersion and vacuum methods in terms of the depth of borate impregnation. This method provides a more effective and complete penetration of the preservative throughout the wood, resulting in better protection against wood-decomposing organisms.

### Modeling

To optimize the use of chemical agents, reduce the cost of treatment, and improve the durability and performance of wood products, it is essential to predict the flow rate of the self-flowing treatment. A mathematical model of self-flowing treatment can better understand the whole process and predict the time required for complete penetration and distribution of the chemical solution throughout the wood structure. The model considers the physical properties of the wood, such as porosity and density, and the chemical properties of the treatment solution, such as the concentration, viscosity. By simulating the flow and diffusion of the solution in the wood, the model can determine the optimal conditions for treatment and predict the time required for achieving the desired level of protection. It can improve the efficiency of wood treatment by reducing the need for trial and error, optimizing the use of chemical agents, and ensuring consistent quality and performance of treated wood products.

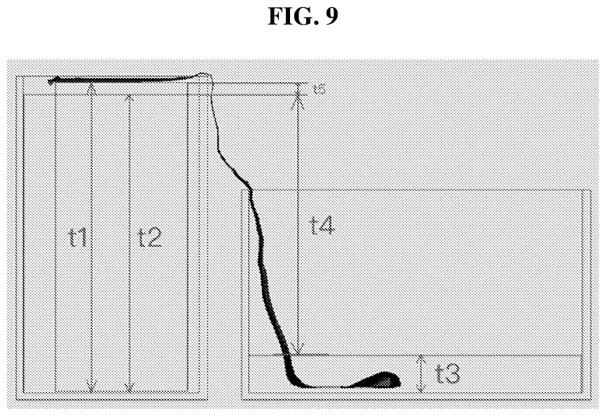

FIG. 9 shows an analysis of heights and liquid levels based on the embodiment shown in FIG. 1. In FIG. 9:
t1 is the height of the wood
t2 is the height of the liquid level 6 (t2<t1)
t3 is the height of the liquid level 7 (t3<t2)
t4 is the distance from the liquid level 6 to the liquid level 7 (t4=t2−t3>0)
t5 is the distance from the top of the wood to the liquid level 6 (t5 t1−t2>0)

Technically, there is no limit on the height of the wood to be treated. The depth of the wood immersed in the liquid, t2, should be less than the height of the wood t1. It is recommended that t2 is 50% to 99% of the height of the wood. The magnitude of t2 directly determines the hydraulic pressure at the bottom of the wood. The higher the pressure, the easier for the liquid to penetrate the wood. t5 is the distance of the wood above the liquid surface 6. The distance prevents the liquid from directly contacting the absorbent sheet. It is recommended that t5 is greater than 1 mm. T4 is the difference between t3 and t2. T4 will affect the moving speed of the liquid, which the absorbent sheet draws from the wood. It is recommended that t4 is greater than 1 cm.

During the treatment process, the liquid in Tank 1 continuously flows to Tank 2, resulting in a decrease in t2 and an increase in t3, which slows down the liquid flow speed through the wood. Therefore, t2 and t3 need to be controlled during the process.

The self flowing process can be described through the following equation:

$$Q = ( \frac{N π ( \frac{2 γ}{{r}_{w}} cos θ ( \frac{{t}_{4}}{{t}_{4} + 0.01} ) + ( \frac{{r}_{w}}{{r}_{s}} ) ρ {gt}_{4} )}{8 η ( {t}_{1} + {( \frac{{r}_{w}}{{r}_{s}} )}^{4} {t}_{4}} {r}_{w}^{4} ) ( ψ \frac{2 {t}_{2} ( W + T )}{WT} + 1 )$$

where
Q is the volumetric flow rate;
N is the total number of capillaries;
   where

$$N = ( 1 - \frac{{ρ}_{w}}{1500} ) \frac{A}{π {r}_{w}^{2}} ,$$

where
A is the cross-sectional area of the wood, and ρ_{w} is the density of wood;
rₛ is the average capillary radius of the sheet and r_{w} is the average capillary radius of the wood which can be measured experimentally;
η is the viscosity of the chemical liquid, which can be determined through experimentation or by referring to a table;
γ is the surface tension of the liquid and θ is the contact angle, which can be determined through experimentation or by referring to a table;
t₁ is the height of the wood;
t₂ and t₃ are the height of the liquid level of treatment solution;
t₄ is the height difference between the two liquid levels;
ρ is the density of the liquid;
g is the acceleration due to gravity;
ψ is the ratio of lateral liquid diffusion to axial diffusion in wood, typically 0.028;
W is the width of the wood sample; and
T is the thickness of the wood sample.

Based on the above equation, maximizing the value of t2 would result in a faster flow rate Q. It is important to ensure that the absorbent sheet does not touch the liquid surface while keeping t2 as close to t1 as possible. Otherwise the absorbent sheet will draw the liquid directly from the container but not from the wood.

Therefore, the time required for the treatment liquid to flow completely through the wood can be expressed as:

$$time = \frac{{At}_{1}}{Q}$$

where V is the volume of the wood sample.

To validate the prediction model, Basswood and Balsa wood blocks of different sizes and height were treated at 25° C. using 4% wt borate.

For Basswood, Table 1 below shows the parameter values that were used to calculate the flow rate and treatment time.

TABLE 1

| | | |
|---|---|---|
| r_{w}= | 1.06E−06 | m |
| rₛ= | 4.91E−06 | m |
| η= | 1.00E−03 | Pa*s |
| ρ= | 1.03E+3 | KG/m³ |
| g= | 9.8 | m/s |
| θ= | 8.70E+01 | degree |
| ψ= | 2.80E−02 | |
| ρ_{w}= | 4.50E+02 | KG/m³ |
| γ= | 7.18E−02 | N/m |

All the test data gathered were based on blocks of wood measuring 5 cm×5 cm×5 cm, unless stated otherwise.

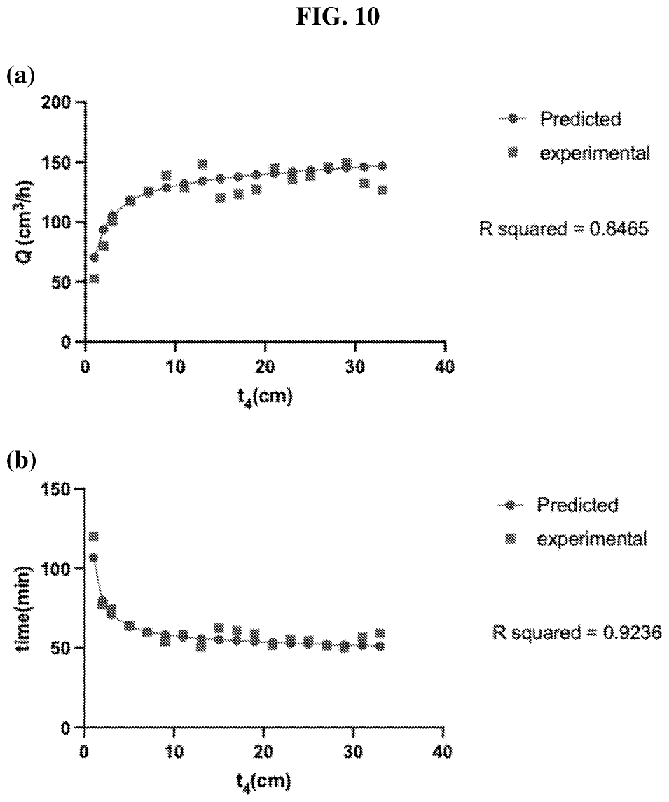

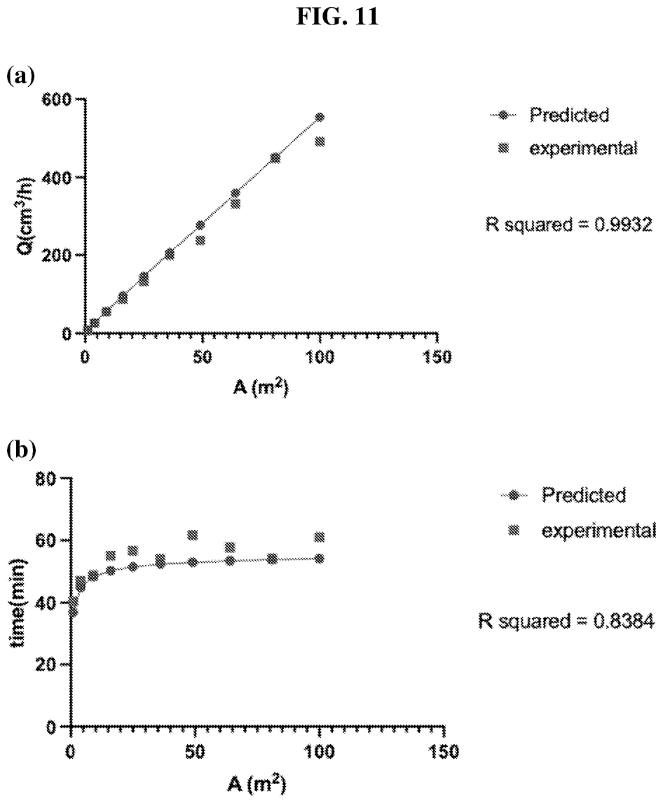

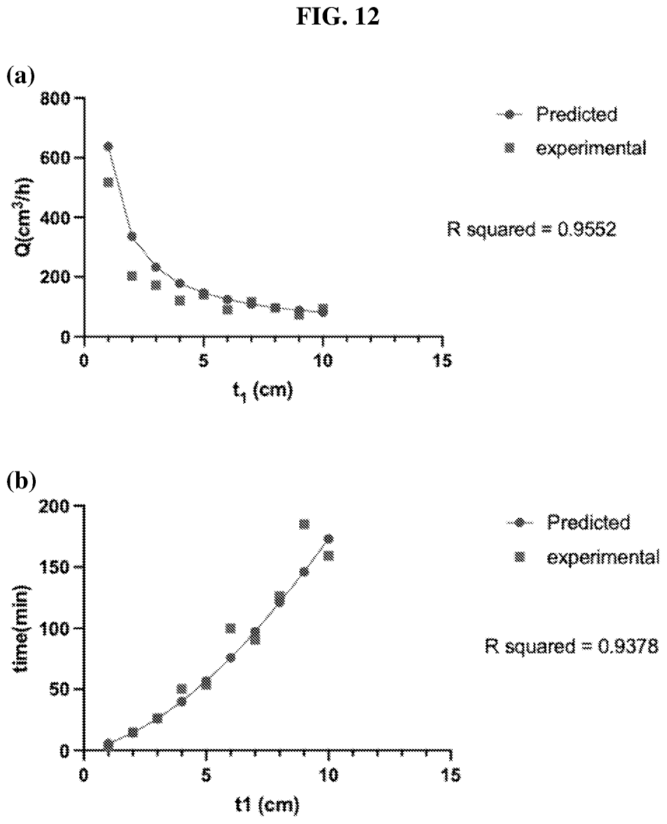

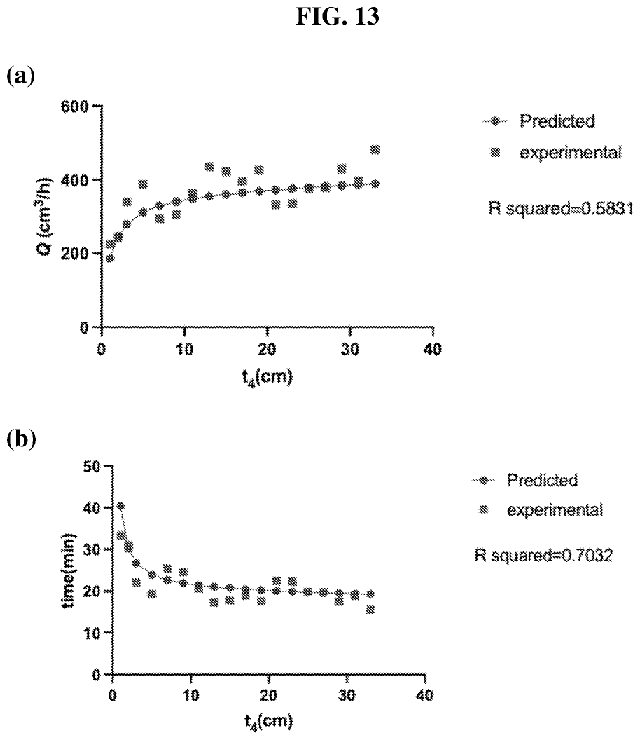

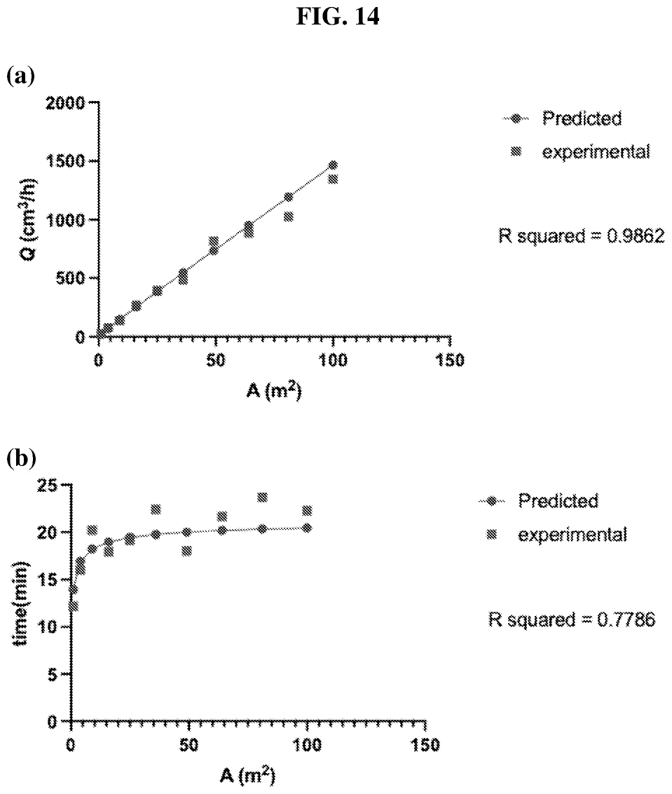

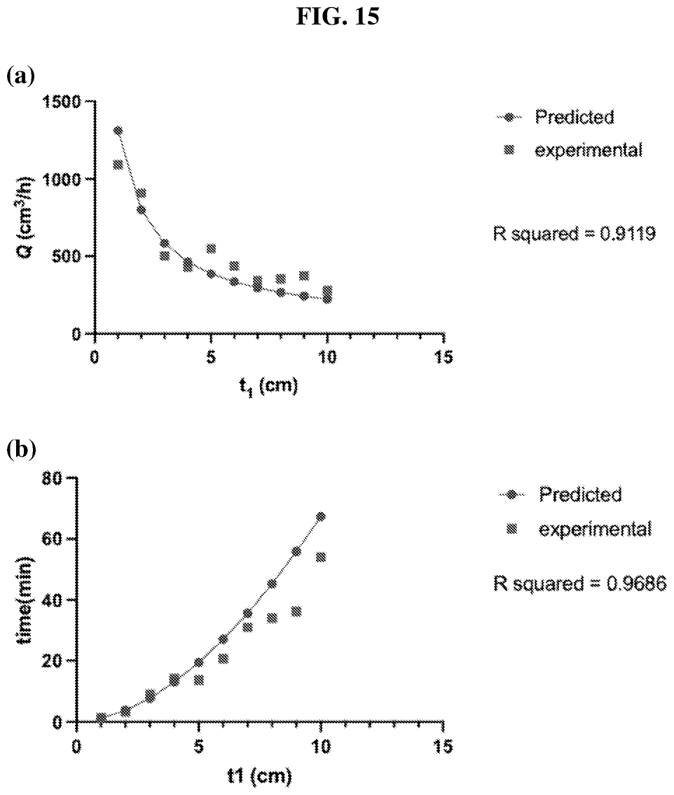

FIG. 10 shows (a) the relationship between the liquid level differences (t4) and borate flow rate and (b) the relationship between the liquid level differences (14) and the time required to completely treat the wood.

FIG. 11 shows (a) the relationship between the cross-sectional area of wood (A) and the borate flow rate, and (b) the time required for complete treatment of wood with different cross-sectional areas.

FIG. 12 shows (a) the relationship between the height of wood (t1) and the flow rate of borate, and (b) the relationship between the height of wood (t1) and the time required for complete treatment.

For Balsa Wood, Table 2 below shows the parameter values that were used to calculate the flow rate and treatment time.

TABLE 2

| | | |
|---|---|---|
| r_{w}= | 1.76E−06 | m |
| rₛ= | 4.91E−06 | m |
| η= | 1.00E−03 | Pa*s |
| ρ= | 1.03E+3 | KG/m³ |
| g= | 9.8 | m/s |
| θ= | 8.60E+01 | degree |
| ψ= | 2.80E−02 | |
| ρ_{w}= | 2.50E+02 | KG/m³ |
| γ= | 7.18E−02 | N/m |

Again, all the test data gathered were based on blocks of wood measuring 5 cm×5 cm×5 cm, unless stated otherwise.

FIG. 13 shows (a) the relationship between the liquid level differences (t4) and borate flow rate and (b) the relationship between the liquid level differences (t4) and the time required to completely treat the wood.

FIG. 14 shows (a) the relationship between the cross-sectional area of wood (A) and the borate flow rate, and (b) the time required for complete treatment of wood with different cross-sectional areas.

FIG. 15 shows (a) the relationship between the height of wood (t1) and the flow rate of borate, and (b) the relationship between the height of wood (t1) and the time required for complete treatment.

Theoretical and experimental research of the self-flowing process have shown that the computational outcomes from the present model exhibit strong agreement with the experimental data. This demonstrates the self-flowing treatment model's validity and dependability in estimating the time needed for chemically treating wood. The outcomes of this model may be used to lower the cost of treatment, increase the performance and durability of wood products, and optimize the usage of chemical agents.

What is claimed is:

1. A self-flowing system for treatment of porous material, comprising:
a treatment solution;
a treatment container, wherein the treatment container is at least partially filled with the treatment solution;
a porous material to be treated, wherein the porous material has a lower surface and an upper surface; wherein the porous material is placed in the treatment container and immersed at least partially in the treatment solution, and wherein the upper surface of the porous material is not immersed in the treatment solution;
a storage container; and
an absorbent material that traverses between the treatment container and the storage container and is in contact with the upper surface of the porous material, wherein the treatment solution flows from the treatment container to the storage container through the porous material and the absorbent material, wherein the treatment solution passes from the lower surface of the porous material through the porous material to an upper surface of the porous material via capillary force.

2. The self-flowing system of claim 1, wherein the porous material is wood, bamboo, or other porous materials.

3. The self-flowing system of claim 1, wherein the treatment solution comprises H₂O, H₂O₂, NaClO, NaClO, CH₃COOH, HCOOH, H₂SO₄, ClO₂, Cl₂, NaOH, Na₂S, C₅H₆O₂, NaHSO₃, SO₂, ammonia or amine based preservatives, Na₂SO₃, (C₂H₅)₂O, CH₃OH, C₇H₈O, C₃H₆O, C₂H₅OH, C₄H₆O₃, C₄H₉OH, NH₃, NH₃—H₂O, CH₂Cl₂, C₅H₁₀N₂O₅, H₆NO₄P, borate, particulate suspension, triethanolamine C₁₆H₂₂ClN₃O, C₁₅H₁₇Cl₂N₃O₂, C₆HCl₅O, or combinations thereof.

4. The self-flowing system of claim 1, wherein the absorbent material has a density between 0.1 g/cm³ and 2 g/cm³, an absorption speed greater than 0.1 cm, and a thickness greater than 0.1 inn.

5. The self-flowing system of claim 1, wherein the treatment solution in the treatment container has a height of t2, wherein the treatment solution in the storage container has a height of t3, and wherein the difference between t2 and t3 is greater than 0.04 m.

6. A method for self-flowing treatment of porous material, comprising:
placing a porous material in contact with a treatment solution, wherein the porous material has a lower surface and an upper surface, wherein the lower surface of the porous material is immersed in the treatment solution, and wherein the upper surface of the porous material is not immersed in the treatment solution;
placing an absorbent material in contact with the upper surface of the porous material, whereby the treatment solution passes from the lower surface of the porous material through the porous material to an upper surface of the porous material via capillary force and whereby the treatment solution flows from the upper surface of the porous material into and through the absorbent material;
collecting the treatment solution after it flows through the absorbent material; and
removing the porous material from the treatment solution to produce a treated porous material.

7. The method of claim 5, wherein the porous material is wood, bamboo, or other porous materials.

8. The method of claim 5, wherein the treatment solution comprises H₂O, H₂O₂, NaClO, NaClO, CH₃COOH, HCOOH, H₂SO₄, ClO₂, Cl₂, NaOH, Na₂S, C₅H₆O₂, NaHSO₃, SO₂, ammonia or amine based preservatives, Na₂SO₃, (C₂H₅)₂O, CH₃OH, C₇H₈O, C₃H₆O, C₂H₅OH, C₄H₆O₃, C₄H₉OH, NH₃, NH₃—H₂O, CH₂Cl₂, C₅H₁₀N₂O₅, H₆NO₄P, borate, particulate suspension, triethanolamine C₁₆H₂₂ClN₃O, C₁₅H₁₇Cl₂N₃O₂, C₆HCl₅O, or combinations thereof.

9. The method of claim 5, wherein the absorbent material has a density between 0.1 g/cm³ and 2 g/cm³, an absorption speed greater than 0.1 cm, and a thickness greater than 0.1 mm.

10. The method of claim 5, wherein the treated porous material has a reduced lignin content and improved thermal insulation properties.

11. The method of claim 6, wherein the porous material is placed in contact with the treatment solution in a treatment container, and wherein the treatment solution is collected in a storage container after it flows through the absorbent material.

12. The method of claim 11, wherein the treatment solution in the treatment container has a height of t2, wherein the treatment solution in the storage container has a height of t3, and wherein the difference between t2 and t3 is greater than 0.04 m.
